(19) United States
(12) Patent Application Publication
(10) Pub. No.: US 2010/0068400 A1
(43) Pub. Date: Mar. 18, 2010

(54) COMPOSITION FOR USE AS A PREVENTIVE TEMPORARY FIRE PROTECTION AGENT, THE APPLICATION THEREOF TO PRODUCTS, AND THE PRODUCTION AND USE OF SAME

(76) Inventors: Peter Reimann, Hilden (DE); Guenter Roth, Hilden (DE)

Correspondence Address: K.F. ROSS P.C., 5683 RIVERDALE AVENUE, SUITE 203 BOX 900, BRONX, NY, 10471-0900, US

(21) Appl. No.: 12/516,403

(22) PCT Filed: Oct. 13, 2007
(86) PCT No.: PCT/EP07/08902

§ 371 Date: May 27, 2009

(30) Foreign Application Priority Data
Nov. 29, 2006 (DE) 10 2006 056 661.0

(51) Int. Cl. C09K 21/10; B05D 3/02

(52) U.S. Cl. 427/395; 252/607; 427/397

(57) ABSTRACT

The invention relates to the use of a composition as a preventive temporary fire protection agent, said composition containing: between 2.0 wt. % and 23 wt. %, preferably between 2.0 wt. % and 15 wt. %, especially between 3.0 wt. % and 14.5 wt. %, of diammonium hydrogen phosphate; between 1.0 wt. % and 17 wt. %, preferably 1.0 wt. % and 10 wt. %, especially between 1.0 wt. % and 2.5 wt. % of urea; and between 60 wt. % and 97 wt. %, preferably between 75 wt. % and 97 wt. %, especially between 83 wt. % and 96 wt. % of water. The invention also relates to the application of said composition and to the production and use thereof as a preventive protection agent for checking forest fires and steppe fires.

The present invention relates to a composition as a preventive temporary fire protection agent, its application onto products, its production and its use for the containment of bush and grass fires.

### STATE OF THE ART

The term fire retardant refers to organic and/or inorganic substances that are intended to render particularly wood and wood materials, plastics and textiles flame-resistant. These substances achieve this in that they prevent the ignition of materials that are to be protected. (Römpp-Lexikon Chemie [Römpp's Encyclopedia of Chemistry], published by Georg Thieme Verlag 1997, 10^{th} Edition, Stuttgart/New York, page 1352 f).

According to Wikipedia, fire retardants are broken down into inorganic fire retardants including, among others, ammonium phosphates as well as into halogenated fire retardants, organophosphorous fire retardants and nitrogen-based fire retardants, including, among others, urea.

A non-toxic fire retardant based on ammonium dihydrogen phosphate (=monoammonium phosphate) is advertised and sold on the Internet under the name Antiflame®.

Cotton fabrics can be rendered flame-retardant by means of ammonium polyphosphates that are (in)soluble in water (British patents GB-A-1069946, GB-A-1504507).

East German patent DD 287 550 A5 relates to an aqueous formulation for rendering substances flame-resistant and containing 7% to 24% by weight of a fluoropolymer dispersion in addition to ammonium phosphate, water and urea, and it also relates to a method for rendering a substrate fire-resistant by means of impregnation, drying and curing.

European patent application EP 449 159 B1 (=Japanese patent application JP-A-4214471) relates to a fire-retardant finish consisting of a water-soluble and a water-insoluble ammonium polyphosphate, a surfactant, a heat-curable synthetic resin, urea and water, and it also relates to a method to create a flame-retardant finish for woven and non-woven materials, especially those made of cellulose, by means of impregnation and heat-curing.

The above-mentioned publications relate to heat-curing formulations containing binders that provide textiles with a permanent flame-retardant finish, but they do not relate to is preventive temporary fire protection agents.

### DESCRIPTION OF THE INVENTION

The present invention is based on the objective of providing a special composition which consists of only two active ingredients as a preventive temporary fire protection agent and which, unlike the halogenated fire retardants and the organophosphorous fire retardants, is safe to use and is applied onto the product to be protected against fire very rapidly and easily.

This objective is achieved by a preventive temporary fire protection agent.

Therefore, the invention relates to the use of a composition as a temporary fire protection agent, containing
2.0% to 23% by weight, preferably 2.0% to 15% by weight, especially 3.0% to 14.5% by weight, of diammonium hydrogen phosphate (=diammonium phosphate);
1.0% to 17% by weight, preferably 1.0% to 10% by weight, especially 1.0% to 2.5% by weight, of urea;
60% to 97% by weight, preferably 75% to 97% by weight, especially 83% to 96% by weight, of water.

The term preventive “temporary fire protection agent” relates to the readily water-soluble composition defined in the claims, which is applied prior to a fire onto the surface of the products to be protected against fire. If the substrate is absorbent, the active components diffuse into the objects to be protected, whereas if the material is not absorbent, they remain on the surface and form a colorless protective film.

Therefore, the subject matter of the present invention is not a fire extinguishing agent that is only applied to the source of the fire after the onset of the fire.

The subject matter likewise does not comprise impregnations, in other words, the impregnation of porous flammable materials in order to render them permanently fire resistant.

According to a preferred embodiment, the composition employed as a preventive temporary fire protection agent contains, relative to 100 parts by weight of the composition, 0% to 1% by weight of at least one chelating agent, whereby the chelating agent is selected from among polyoxycarboxylic acids, polyamines, EDTA and/or NTA.

According to another preferred embodiment, the composition contains, relative to 100 parts by weight of the composition, 0% to 7% by weight of familiar auxiliaries and additives, which are selected from among cross-linking agents, binders and thickeners as well as dyes.

According to another preferred embodiment, the composition contains, relative to 100 parts by weight of the composition, 0% to 1% by weight of a water softener, especially an alkali phosphate, and/or 0% to 3% by weight of surfactants, particularly anionic, non-ionogenic or amphoteric surfactants or mixtures thereof, and/or 0% to 3% by weight of binders or thickeners, especially water-soluble cellulose derivatives or other water-dilutable film-forming agents, depending on the substrate to be protected or on the application, and/or 0% to 0.2% by weight of water-soluble dyes.

According to a preferred embodiment, the products treated is with the composition are paper, pasteboard, cardboard, decorations, deciduous trees, coniferous trees, bushes, shrubs, grasses, parts thereof, arrangements thereof or products thereof.

Examples of such products are decoration materials (garlands, paper lanterns, paper flowers), wood derivatives, brush wood in forests, bushes, hay, straw, dried flowers.

According to another preferred embodiment, the flammable product is a deciduous tree or a coniferous tree, parts thereof or arrangements thereof, a Christmas tree, a holiday wreath or an evergreen arrangement.

Production:

Another subject matter of the present invention is the provision of a production method for the above-mentioned composition.

This is achieved by means of the features of the production claim.

Therefore, the invention relates to methods for the production of the composition of the type described above, whereby first of all 2.0 to 23 parts by weight of diammonium hydrogen phosphate and 1.0 to 17 parts by weight of urea and, if applicable, the above-mentioned auxiliaries and additives, are brought into contact with each other, especially mixed together, optionally ground up and then dissolved in 60 to 97 parts by weight of water.

Application of the composition:

Moreover, the present invention relates to a method for applying the composition onto a specific flammable product.

This objective is achieved by means of the features of the other method claims.

Thus, the invention relates to a method for applying the composition of the type described above, whereby an aqueous solution consisting of 2.0% to 23% by weight, preferably 2.0% to 15% by weight, especially 3.0% to 14.5% by weight, of diammonium hydrogen phosphate, 1.0% to 17% by weight, preferably 1.0% to 10% by weight, especially 1.0% to 2.5% by weight, of urea, 60% to 97% by weight, preferably 75% to 97% by weight, especially 83% to 96% by weight, of water is applied continuously or discontinuously onto the surface of the flammable product.

In the method according to the invention, preference is given to carrying out the application by means of injecting, spraying, rolling, dipping, impregnating or brushing, followed by drying at ambient temperature.

Concentrate:

Another subject matter of the present invention is the provision of a concentrate for preventive temporary fire protection that can be converted on site into the appropriate aqueous composition.

This objective is achieved by means of the features of the concentrate claim.

Thus, the invention relates to a concentrate for preventive temporary fire protection consisting of

60% to 95% by weight of diammonium hydrogen phosphate,

5% to 39% by weight of urea, and

0% to 1% by weight of alkali phosphate.

Uses:

The subject matter of the present invention is likewise the use of two active ingredients in combination with a solvent as a flame-retardant agent for the containment of bush and grass fires.

This objective is achieved by means of the features of claim 11.

Thus, the invention relates to the use of a composition consisting of 2.0% to 23% by weight, preferably 2.0% to 15% by weight, especially 3.0% to 14.5% by weight, of diammonium hydrogen phosphate, 1.0% to 17% by weight, preferably 1.0% to 10% by weight, especially 1.0% to 2.5% by weight, of urea, 60% to 97% by weight, preferably 75% to 97% by weight, especially 83% to 96% by weight, of water, as a preventive temporary fire protection agent.

According to a preferred embodiment, the above-mentioned composition is employed to create a flame-retardant finish for flammable materials such as deciduous trees or coniferous trees or products thereof, especially parts of these trees or arrangements thereof, a holiday wreath or an evergreen arrangement as well as other products of plant origin.

Another subject matter of the present invention is the use of the finish as a preventive protection agent against fire, especially for the containment of bush and grass fires.

Thus, the invention relates to the use of a composition consisting of 2.0% to 23% by weight, preferably 2.0% to 15% by weight, especially 3.0% to 14.5% by weight, of diammonium hydrogen phosphate, 1.0% to 17% by weight, preferably 1.0% to 10% by weight, especially 1.0% to 2.5% by weight, of urea, 60% to 97% by weight, preferably 75% to 97% by weight, especially 83% to 96% by weight, of water, as a preventive temporary fire protection agent, is especially for the containment of bush and grass fires.

Therefore, the invention relates to the use of the flame-retardant finish of the above-mentioned type and/or the application according to the above-mentioned method, as a preventive protection agent against fire, for preventing the propagation of flames in the case of flammable organic materials.

### EMBODIMENTS

The present invention will be elaborated upon in greater detail below by embodiments in the form of production examples and application examples, which demonstrate that the composition according to the invention can be employed as a preventive temporary fire protection agent.

### Production Example

A mixture consisting of 18 kg of diammonium hydrogen phosphate, 11.7 kg of urea and 0.3 kg of sodium polyphosphate is ground up in a ball mill or cone mill until it is homogeneous. The resultant fine-grained pulverulent mixture dissolves quickly and residue-free in 100 liters of water.

### Application Example 1

An amount of 100 liters of the 30%-solution described above were sprayed onto a large open terrain containing dry bushes and grasses over a circular surface area of about 150 square meters using a motor-powered pressurized spraying device, so that the bushes and grasses within the circular area were uniformly wetted. Once the sprayed solution had dried, the area was set on fire in the wind direction towards the circular area under the supervision of the fire department. The result was that the bushes and grasses on the open area were consumed by the fire while the plants treated with the flame retardant inside the circular area were spared. The residues of the composition according to the invention on the plants that had not burned are not harmful to nature since they are washed off by rain and they then act as fertilizer.

### Application Example 2

A solution consisting of 15% by weight of diammonium hydrogen phosphate, 5% by weight of urea, 2% by weight of anionic and non-ionogenic surfactants in 78% by weight of water was sprayed onto pine tree branches by means of a spray bottle. After the branches had dried, an attempt was made to set fire to them using a candle. It was found that it was much more difficult to ignite the pine tree branches treated with the preventive temporary fire-protection agent than the untreated branches in a comparative experiment. Moreover, the afterglow in the treated specimen was markedly reduced.

### Application Example 3

The test below shows the preventive temporary fire-protection effect of the composition according to the invention in 5% to 20%-aqueous solutions at different concentrations of the two active ingredients.

Test series A - 20%-solutions

| | | | Diammonium | Visual assessment |
|---|---|---|---|---|
| | Water | Urea | phosphate | of flame protection |
| A1 | 100 g + | 2 g | 18 g | 1 |
| A2 | 100 g + | 5 g | 15 g | 1 |
| A3 | 100 g + | 10 g | 10 g | 2 |
| A4 | 100 g + | 15 g | 5 g | 3 |
| A5 | 100 g + | 20 g | 0 g | 5 |

Test series B - 10%-solutions

| | | | Diammonium | Visual assessment |
|---|---|---|---|---|
| | Water | Urea | phosphate | of flame protection |
| B1 | 100 g + | 1.0 g | 9.0 g | 1-2*⁾ |
| B2 | 100 g + | 2.5 g | 7.5 g | 1-2 |
| B3 | 100 g + | 5.0 g | 5.0 g | 3 |
| B4 | 100 g + | 7.5 g | 2.5 g | 4 |
| B5 | 100 g + | 10.0 g | 0.0 g | 5 |

Test series C - 5%-solutions

| | | | Diammonium | Visual assessment |
|---|---|---|---|---|
| | Water | Urea | phosphate | of flame protection |
| C1 | 100 g + | 0.50 g | 4.50 g | 2-3 |
| C2 | 100 g + | 1.25 g | 3.75 g | 2-3 |
| C3 | 100 g + | 2.50 g | 2.50 g | 4 |
| C4 | 100 g + | 3.75 g | 1.25 g | 5 |
| C5 | 100 g + | 5.00 g | 0.00 g | 5 |

### Execution of the Experiment

Strips of absorbent paper were impregnated over half of the surface with the above-mentioned solutions and dried in air. The papers were subsequently hung with the non-impregnated side facing down and then ignited by placing a tea candle underneath them. The unprotected segments burned up completely in all cases. The flame-retardant effect was assessed visually by comparing the unburned residual lengths of the impregnated segments.
Grade 1 excellent flame protection (unburned residual length of 80% to 100%)
Grade 2 good flame protection (unburned residual length of 60% to 80%)
Grade 3 clearly recognizable flame-retardant effect (unburned residual length of 30% to 60%)
Grade 4 weak flame-retardant effect (unburned residual length<30%)
Grade 5 no detectable flame-retardant effect (paper burns up)

### Conclusion Regarding Application Example 3

In comparison to diammonium hydrogen phosphate, urea does not exhibit any significant flame-retardant effect of its own. The effect of diammonium hydrogen phosphate is pronounced and increases with the application concentration. Apparently, however, some of the effective diammonium hydrogen phosphate can be replaced by urea without impairing the preventive temporary fire protection.

### DECLARATION CITED IN ARTICLE 19(1)

As is explained on page 3, in the last three paragraphs of the present description as well as in claims 5, 12, the subject matter of the present invention is a readily water-soluble composition consisting of two active ingredients, which is applied prior to a fire onto the surface of the products to be protected against fire (in other words, finished products, commercial products). If the substrate is absorbent, the active components diffuse into the objects to be protected whereas, if the material is not absorbent, they remain on the surface and form a colorless protective film. Consequently, the present invention does not relate to a fire extinguishing agent and it likewise does not relate to impregnations that are applied onto a semi-finished product, a preliminary product, during the production process.

According to page 4 of international patent application WO 90/13699 A2, this publication has the objective of putting forward a ternary flame-retardant composition containing, in addition to urea and monoammonium phosphate or diammonium phosphate, at least one ammonium halide (for instance, ammonium chloride) as the essential component of the composition. This additional component is not needed according to the invention. Perhaps it is precisely the ammonium halides in this mixture that have a synergistic or catalytic effect. According to page 6, the flame protection is achieved by impregnating textiles and wood products. Moreover, claims 15 to 18 claim the preparation as a fire-extinguishing agent (extinguishing water) but not to preventive temporary fire protection to which the present invention is restricted, for example, in case of bush fires.

According to page 2 of German patent application DE 18 17 535 A1, this publication has the objective of creating a printable paper that does not burn in air or in a pure oxygen atmosphere. This objective is achieved in that during the industrial paper-production process, the raw paper is impregnated with an aqueous solution of flame-retardant substances such as diammonium phosphate and urea, then smoothed and finally compacted, as can be gleaned from Example 2. A preventive temporary treatment of a final product or finished product with the composition according to the invention that can serve to fight fires, especially bush fires, is neither disclosed nor suggested there.

European EP-A-0 277 932 relates to the thickening of is aqueous flame-protection concentrates. Diammonium phosphate, among others, is mentioned as one of the described flame-retardant constituents, but urea is not mentioned. In contrast to the thickened aqueous concentrates, our preparation is a powder without thickening agents.

U.S. Pat. No. 4,264,320 relates to the production of black textiles with a flame-resistant finish created by impregnation and subsequent heating to at least 220° C. [428° F.]. Except for the components diammonium phosphate and urea, which were cited among others, this patent does not have anything in common with the invention being claimed, that is to say, preventive temporary firefighting.

U.S. Pat. No. 2,935,471 relates to flame-retardant preparations using, among other things, diammonium phosphate, but not using urea. Moreover, boron compounds are essential constituents of the composition known from the state of the art. Furthermore, the textiles and paper are impregnated at 135° C. [275° F.].

British Patent 2,301,122 relates to flame-retardant compositions. However, the preventive temporary fighting of fires, especially bush fires, is neither disclosed nor suggested there.

1-13. (canceled)

14. Use of a composition containing
2.0% to 23% by weight of diammonium hydrogen phosphate;
1.0% to 17% by weight of urea; and
60% to 97% by weight of water
as a temporary fire protection agent for paper, pasteboard, cardboard, decorations, deciduous trees, coniferous trees, bushes, shrubs, grasses, parts thereof, arrangements thereof or products thereof.

15. The use according to claim 14 wherein the composition additionally contains, relative to 100 parts by weight of the composition, 0% to 1% by weight of at least one chelating agent selected from among polyoxycarboxylic acids, polyamines, EDTA or NTA or mixtures thereof.

16. The use according to claim 14 wherein the composition contains, relative to 100 parts by weight of the composition, 0% to 7% by weight of familiar auxiliaries and additives selected from among cross-linking agents, binders and thickeners as well as dyes.

17. The use according to claim 16 wherein the composition contains, as auxiliaries and additives, relative to 100 parts by weight of the composition, at least one of or a mixture containing at least two of the following substances:
0% to 1% by weight of a water softener,
0% to 3% by weight of surfactants,
0% to 3% by weight of binders or thickeners, and
0% to 0.2% by weight of water-soluble dyes.

18. The use according to claim 18 wherein the product treated with the composition is a decoration, a deciduous tree or a coniferous tree, parts thereof or arrangements thereof, a holiday wreath or an evergreen arrangement.

19. A method to using a composition comprising 2.0% to 23% by weight of diammonium hydrogen phosphate, 1.0% to 17% by weight of urea, 60% to 97% by weight of water to treat a flammable product, the method comprising the step of
applying the composition to the surface of the flammable product.

20. The method according to claim 19 wherein the application is carried out by means of injecting, spraying, rolling, dipping, impregnating or brushing, followed by drying at ambient temperature.

21. A concentrate for preventive temporary fire protection, the concentrate consisting of:
60% to 95% by weight of diammonium hydrogen phosphate,
5% to 39% by weight of urea, and
0% to 1% by weight of alkali phosphate.

22. The use of a composition according to claim 21 wherein prior to use the concentrate is dissolved in water to form a 10% to 40%-solution as a preventive temporary fire protection agent.

23. Use of a composition consisting of 2.0% to 23% by weight of diammonium hydrogen phosphate; 1.0% to 17% by weight of urea; 60% to 97% by weight of water as a preventive temporary fire protection agent on flammable materials.

24. The use according to claim 23 wherein the flammable materials are decorations, deciduous trees, coniferous trees, underbrush, shrubs, grasses, parts thereof, arrangements thereof or products thereof.

25. A method of making a composition comprising the step of:
mixing 2.0 to 23 parts by weight of diammonium hydrogen phosphate in particulate form with 1.0 to 17 parts by weight of urea in particulate form and thereafter
dissolving the mixture in 60 to 97 parts by weight of water.
